(19) United States
(12) Patent Application Publication
(10) Pub. No.: US 2024/0247577 A1
(43) Pub. Date: Jul. 25, 2024

(54) PROBABILISTIC DETECTION OF DRILLING SCENARIOS

(71) Applicant: Baker Hughes Oilfield Operations LLC, Houston, TX (US)

(72) Inventor: Andreas Hohl, Hannover (DE)

(21) Appl. No.: 18/416,487

(22) Filed: Jan. 18, 2024

Related U.S. Application Data
(60) Provisional application No. 63/440,024, filed on Jan. 19, 2023.

(51) Int. Cl. E21B 44/00; E21B 7/06

(52) U.S. Cl. CPC E21B 44/00; E21B 7/06; E21B 2200/20

(57) ABSTRACT

A method of performing a drilling operation includes acquiring sensor data during a drilling operation performed in a subterranean region, estimating a first probability P_{A} of a drilling scenario manifesting if a first action is performed, and estimating a second probability P_{NA} of the drilling scenario manifesting if the first action is not performed or a second action is performed. The method includes calculating a break even threshold based on the first probability and the second probability, the break even threshold calculated based on a set of costs including a first cost C_{A} of performing the first action to mitigate the drilling scenario and a second cost C_{NA} associated with the drilling scenario if the first action is not performed or the second action is performed, and based on the acquired sensor data and the break even threshold, performing the first action.

This application claims the benefit of U.S. Provisional Patent Application Ser. No. 63/440,024 filed Jan. 19, 2023, the disclosure of which is incorporated herein by reference in its entirety.

### BACKGROUND

In the resource recovery industry and fluid sequestration industry, boreholes are often drilled through subterranean regions. During a drilling operation, various scenarios can arise that have the potential to affect the efficiency of the operation. When such a scenario occurs, operators and/or control systems typically assess whether to adjust drilling parameters or otherwise react to mitigate the scenario and avoid an increase in drilling time. The effectiveness of such a reaction, in some cases, is affected by the timing of initiation of the reaction.

### SUMMARY

An embodiment of a method of performing a drilling operation includes acquiring sensor data during a drilling operation performed in a subterranean region, estimating a first probability P_{A} of a drilling scenario manifesting if a first action is performed, and estimating a second probability P_{NA} of the drilling scenario manifesting if the first action is not performed or a second action is performed. The method includes calculating a break even threshold based on the first probability and the second probability, the break even threshold calculated based on a set of costs including a first cost C_{A} of performing the first action to mitigate the drilling scenario and a second cost C_{NA} associated with the drilling scenario if the first action is not performed or the second action is performed, and based on the acquired sensor data and the break even threshold, performing the first action.

An embodiment of a system for performing a drilling operation, includes a processing device configured to acquire sensor data during a drilling operation performed in a subterranean region. The processing device is configured to acquire sensor data during the drilling operation, estimate a first probability P_{A} of a drilling scenario manifesting if a first action is performed, and estimate a second probability P_{NA} of the drilling scenario manifesting if the first action is not performed or a second action is performed. The processing device is configured to calculate a break even threshold based on the first probability and the second probability, the break even threshold calculated based on a set of costs including a first cost C_{A} of performing the first action to mitigate the drilling scenario and a second cost C_{NA} associated with the drilling scenario if the first action is not performed or the second action is performed, and based on the acquired sensor data and the break even threshold, perform the first action.

### BRIEF DESCRIPTION OF THE DRAWINGS

The following descriptions should not be considered limiting in any way. With reference to the accompanying drawings, like elements are numbered alike:

FIG. 1 depicts an embodiment of a system for performing a drilling operation, and an embodiment of a monitoring and decision system for monitoring the operation and making decisions related to detected drilling scenarios;

FIG. 2 depicts an example of reference data and a statistical analysis of the reference data for use by the monitoring and decision system;

FIGS. 3A, 3B and 3C depict examples of statistical data for use by the monitoring and decision system;

FIG. 4 is a flow diagram depicting an embodiment of a method of monitoring a drilling operation and making decisions related to detected drilling scenarios;

FIG. 5 depicts an example of statistical data used in performing the method of FIG. 4;

FIG. 6 depicts an example of statistical data used in performing the method of FIG. 4; and

FIG. 7 depicts an example of statistical data for use by the monitoring and decision system.

### DETAILED DESCRIPTION

A detailed description of one or more embodiments of the disclosed apparatus and method are presented herein by way of exemplification and not limitation with reference to the Figures.

Devices, systems and methods for controlling drilling operations are described herein. An embodiment of a monitoring and decision system configured to perform a method that includes monitoring a drilling operation and acquiring sensor data, and estimating a probability of encountering a drilling scenario. In an embodiment, the probability is estimated based on statistical data, which is derived from a statistical analysis of reference data (e.g., measurement data from a similar operation or offset well, a model of the drilling operation, etc.). A “drilling scenario” refers to any condition or situation that could potentially increase drilling time, produce unnecessary wear or damage to downhole components, or otherwise reduce drilling efficiency if not addressed. An example of a drilling scenario is excessive bending due to interaction of a drill string with a stringer or other feature of a subterranean region.

The method includes comparing the estimated probability to a break even threshold or probability threshold to determine whether to perform an action (e.g., a transition to a stringer drilling mode) to mitigate or avoid a drilling scenario. The probability threshold or the break even threshold is calculated based on an expected cost of the drilling scenario, and an expected cost related to performing an action. If the estimated probability is greater than or equal to the probability threshold or the break even threshold, an action is performed to address the drilling scenario.

Embodiments described herein present a number of advantages. For example, the embodiments are able to increase the efficiency and reduce costs associated with drilling scenarios, by providing the ability to effectively predict occurrences of drilling scenarios and make timely decisions, and react optimally based on probability weighted cost estimations. In this way, actions can be initiated early enough to address drilling scenarios while minimizing time loss, and unnecessary actions can be avoided. Other advantages include higher success rates associated with detection of stringers and other drilling scenarios and fewer false alarms. In addition, the embodiments can be consistently incorporated with existing monitoring systems (such as a stringer detection system) and increase the effectiveness thereof.

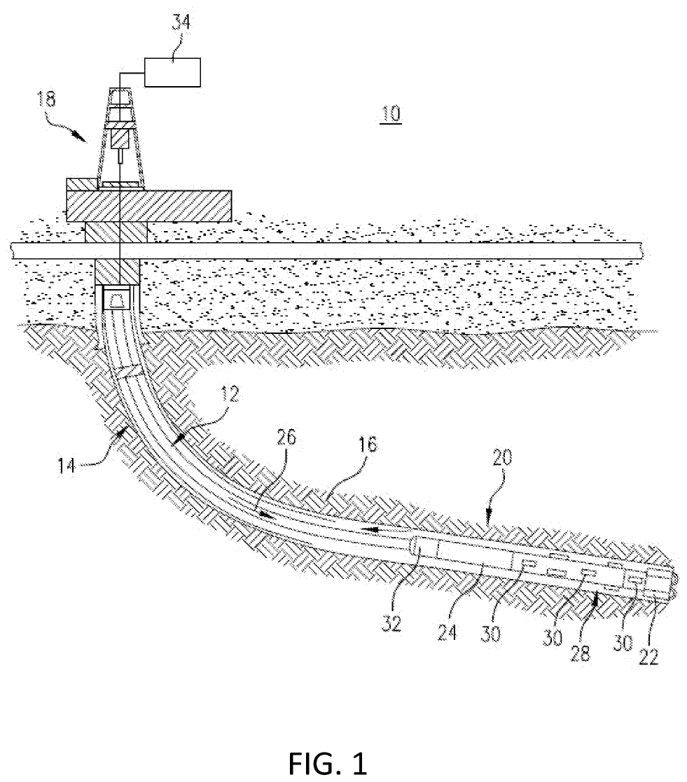

Referring to FIG. 1, an embodiment of a borehole system 10 includes a string 12 disposed within a borehole 14 that penetrates at least one subterranean region. The string 12 is operably connected to a surface structure or surface equipment such as a drill rig 18. Embodiments of a monitoring system may be disposed within or as a part of the string 12, the drill rig 18 and/or a remote system in communication with the borehole system 10.

The system 10 can be used to performing a subterranean operation (e.g., drilling, measurement, stimulation and/or production). In an embodiment, the borehole string 12 is a drill string connected to one or more downhole components (e.g., downhole tools), which may be configured as a bottomhole assembly (BHA) 20. The BHA 20 includes a drill bit 22, which in this embodiment is driven from downhole, e.g., by a downhole mud motor 24. The system 10 may include components to facilitate circulating fluid 26 such as drilling mud through the borehole string 12 and the borehole 14.

The system 10 includes a steering assembly 28 configured to steer or direct a section of the borehole string 12 and the drill bit 22 along a selected path. Examples of steering assemblies include steerable motor assemblies (e.g., bent housing motor assemblies), whipstocks, turbines and rotary steerable systems.

The system 10 also includes a controller configured to operate the steering assembly 28 based on directional information derived from directional sensors located in the borehole string 12. The directional sensors include, for example, one or more gyroscopes (gyroscope sensors or earth rate sensor sensors), one or more magnetometers (magnetic field sensors) and/or one or more accelerometers (acceleration sensors). For example, one or more sensor assemblies 30 are configured to perform measurements of parameters related to the position and/or direction of the borehole string 12, drill bit 22 and/or the steering assembly 28. The sensor assemblies 30 may be located at one or more of various locations, such as on the steering assembly 28, at or near the drill bit 22 and/or on other components of the borehole string 12 and/or BHA 20.

One or more downhole components and/or one or more surface components may be in communication with and/or controlled by a processor such as a downhole processor 32 and/or a surface processing unit 34. The surface processing unit 34 (and/or the downhole processor 32) may be configured to perform functions such as controlling drilling and steering, controlling the flow rate and pressure of borehole fluid, controlling weight on bit (WOB), transmitting and receiving data, processing measurement data, and/or monitoring operations of the system 10.

The BHA 20 may include, or be connected to, a telemetry system configured to transmit data from the BHA 20 to the surface processing unit 34 (uplink) and transmit data from the surface processing unit 34 to the BHA 20 (downlink). The telemetry system may be a mud pulse telemetry system, an electromagnetic telemetry system, an acoustic telemetry system, or a wired pipe telemetry system.

In the embodiment of FIG. 1, the system 10 is configured to perform a drilling operation and a downhole measurement operation, and the borehole string 12 is a drill string. However, embodiments described herein are not so limited and may have any configuration suitable for performing a subterranean operation.

During drilling, various conditions and scenarios may be encountered for which an adjustment or mitigation is desired. The occurrence of such scenarios may be statistically distributed and thus amenable to statistical analysis to determine probabilities associated with the scenarios. Embodiments described herein provide systems and methods for performing drilling operations and making mitigation decisions based on the probabilities.

Features of a formation, such as variations in the composition of the region, can cause operational inefficiencies related to and/or caused by drilling scenarios. An adjustment to operational parameters may be desired to mitigate such inefficiencies (e.g., associated with drilling scenarios) or avoid such features. For example, “stringers” or sections of a region corresponding to a change in lithology, can cause local doglegs, bit wear, damage, and other inefficiencies. For example, when drilling in a sand formation, calcite stringers (e.g., layers or scattered local stringers) can be encountered. Mitigating actions can be performed when stringers are encountered, such as adjusting drilling parameters from a higher ROP (e.g., 100 meters/hour or m/h) during a sand drilling mode to a lower ROP during a stringer mode. In this example, the local dogleg caused by the encountered stringer is considered the drilling scenario associated with or causing the inefficiencies.

Probabilities of stringers are based on the recognition that locations of stringers, stringer geometry, the part of a stringer hit by a drilling assembly, and the angle of attack are statistically distributed. In addition, other features and drilling scenarios may be statistically distributed, such as the occurrence of stick-slip.

The probability of encountering a drilling scenario may be calculated based on considerations that include statistical probabilities (e.g., estimated based on offset well data), sensor data, and/or a statistical attribute or attributes of the sensor data (e.g., rate of change, running average of measurement values of operational parameters, drilling parameters, position or direction parameters, etc.). For example, measurement values (e.g., bending moment, vibration, etc.) and/or time between scenarios (e.g., mean time to next scenario) can be used to determine a probability of encountering the scenario within some time or depth window. The term “time” or time interval in this context refers to the time during which a drill bit is drilling into the formation and is making drilling progress (drilling deeper). The term “depth” refers to a depth interval drilled by the drill bit in the formation. A specific “depth” of depth interval may be drilled in a specific “time” or time interval. The depth may be a measured depth (MD) or a true vertical depth (TVD).

The system 10 includes a monitoring and decision system, which includes one or more processing devices. For example, the monitoring and decision system may be included in the BHA 24, the steering assembly 28, the surface processing unit 34 and/or the downhole processor 32.

An embodiment of a method generally includes monitoring sensor data during a drilling operation, and determining whether to perform an action based on a probability of encountering a drilling scenario. The method may be performed by a processing system including one or more processing devices, an operator or combination thereof.

The determination is based on a statistical analysis of reference data that includes data collected from offset wells, similar operations, modelling, simulation, tool or component maintenance findings, failure and reliability statistics and/or other suitable sources of information. A statistical analysis of the reference data (also referred to as “statistical data”) is used to estimate a probability that the drilling scenario will be encountered given a set (i.e., one or more) of parameter values. A “set of parameter values” refers to any parameter measurement, combination of parameter measurements and/or statistical attribute of measurement values that are indicative of an upcoming drilling scenario (i.e., a drilling scenario being encountered within a given time or depth window). Probability values derived from the statistical data can be used to select a parameter threshold for which a mitigating action should be performed.

The method utilizes various costs and probabilities related to drilling scenarios and available actions, and uses such costs and probabilities as a decision metric to determine whether or not to take action. An “action” is any change in a drilling operation performed to avoid, mitigate or address a drilling scenario. Costs may be quantified based on time (e.g., an increase in the amount of time needed to perform a drilling operation or a time needed to drill a certain distance), aggregated monetary cost, equipment wear, customer reputation and others.

Generally, a decision may be based on costs, and/or based on costs in combination with probability values as described further herein. An action “A” could be taken if the cost is lower than not taking an action “NA”. If multiple different actions (i.e., A1, A2, etc.) are available, the cost of the actions may be compared to select an action (e.g., select a most efficient action). For example, one set point of drilling parameters may be referred to as action “A1” and another set point of drilling parameters may be referred to as action “A2”. The action A1 may be selected if the cost of the action A1 is less than the cost of action A2 (C_{A2}≥C_{A1}).

The comparison could be generalized to a comparison of different actions A1 and A2, where one action A1 could be “no action” or “NA”. In such a scenario, an action may be performed if a cost (C_{A}) of the action (e.g., change of parameters such as drilling parameters) is less than a cost of not acting (or less than a cost of performing another action), or:

$${C}_{NA} \geq {C}_{A} .$$

In an embodiment, decisions are made using a set of costs, with probabilities that such costs occur, are weighted against each other in different scenarios. A decision may be a decision as to whether an action is taken or not taken (e.g., A or NA), and/or a decision as to which action to take (e.g., the cost of a first action is C_{A}. and the cost of a second action is C_{NA}).

Various sets of costs are defined, in which C_{NA} includes a cost of no action (C_{NA}) if a scenario manifests, and C_{A} includes a cost of acting (C_{A}) if the scenario manifests. The cost C_{NA} may also include a cost of no action (C_{NA,not}) if the scenario does not manifest, and C_{A} may include a cost of acting (C_{A,not}) if the scenario does not manifest.

In an embodiment, the costs are defined for each of a number N (one or more) of different scenarios i, where each drilling scenario is indexed as a scenario i, where i=1 . . . N. Each “i” is related to a potential drilling scenario (e.g., hole cleaning, stringer drilling, stick-slip, or reliability issues due to vibrations or mechanical loads such as bending that occur if the scenario “i” manifests).

For example, a set of costs of no action C_{NA,1} . . . C_{NA,i} is defined for each scenario i, if the scenario i manifests (i.e., the cost of the scenario arising with no mitigating action performed). A set of costs C_{NA,not(1)} . . . C_{NA,not(i)}) are the costs if no action (NA) is taken and the scenario i does not manifest. This could be a scenario where no action is taken and the current parameters (drilling parameters) are kept constant (or adjusted according to a previously set plan without a mitigating action taken).

Another set of costs of acting C_{A,1} . . . C_{A,i} are each defined as a cost if a drilling scenario i manifests and a specific action A is taken (meaning a countermeasure or other mitigating action did not work). C_{A,not(1)} . . . C_{A,not(i)} are costs if a specific action A is taken and the scenario i does not manifest (meaning the countermeasure or other mitigating action did work).

Each cost has a likelihood or probability to occur in a certain drilling scenario. The variables P_{NA,i} and P_{A,i} quantify the probability of a scenario i to manifest if action is not taken or action is taken, respectively. The expected cost is the cost of a certain scenario weighted with the probability that it occurs, P_{NA,i}*C_{NA,i} if no action is taken or P_{A,i}*C_{A,i} if action is taken.

The overall costs and probabilities are used to make a decision as to whether to perform an action to address a likely or upcoming drilling scenario. The decision is based on balancing the various costs and probabilities, represented by:

$${P}_{NA , 1} * {C}_{NA , 1} + ( 1 - {P}_{NA , 1} ) * {C}_{NA , not ( 1 )} + \text{} … + {P}_{NA , i} * {C}_{NA , i} + ( 1 - {P}_{NA , i} ) * {C}_{NA , not ( i )} \geq {P}_{A , 1} * {C}_{A , 1} + ( 1 - {P}_{A , 1} ) * {C}_{A , not ( 1 )} + \text{} … + {P}_{A , i} * {C}_{A , i} + ( 1 - {P}_{A , i} ) * {C}_{A , not ( i )} + {C}_{ADJUSTMENT} .$$

In the above relation, C_{ADJUSTMENT} is a cost (or sum of costs) related to an adjustment of drilling or other operational parameters. P_{NA,i}*C_{NA,i} is the probability weighted cost that occurs if a scenario i manifests and no action is taken, where P_{NA,i} is the probability that the scenario i occurs if no action is taken. (1−P_{NA,i}), in contrast, is the probability that the scenario i does not manifest and no action is performed. “1” describes the whole probability; the probability of a scenario occurring or not occurring will sum up to 1 or 100% (this could be another similar normalized value of any kind indicating the whole probability). (1−P_{NA,i})*C_{NA,not(i)} describes the expected probability weighted cost if an action is not taken (NA) and the scenario i does not occur. Similar considerations can be made for the other parts of the equation.

The expected value of the cost that is calculated can be a mean value or a median value but also a quantile or percentile of a distribution. Both the probability and the cost could be described with a probability density function describing a distribution of expected costs (e.g., calculated by Monte Carlo Simulations). Any characteristic value of this probability density function could be taken as decision metric (in addition to or independent of the mean or median value) such as variances or other statistical moments.

Interdependencies between different scenarios “i”, “j” and related costs may be neglected. For example, it could be that a scenario “i” will always exclude another scenario “j”, which would lead to an interdependency of the cost which could be covered by a covariance of the probabilities or the like. For example, during stringer drilling, a high local dogleg scenario “i” could exclude a damaged bit scenario “j” if it is assumed that a local dogleg would lead to high bending and lower weight on bit (assumed to be less damaging for bits).

In an embodiment, determination as to whether to perform an action includes using a cost function indicative of an importance of a given scenario, which could affect the decision regardless of costs. For example, a cost function can be used as a selection criterion, where an action is taken if C_{NA}≥C_{A} or if C_{NA}=C_{A}.

In another example, a safety margin K or other margin value could be implemented to avoid a scenario that does not only lead to monetary cost but also to negative effects with respect to an acceptance criteria or customer reputation. The cost function can be represented by C_{NA}≥K*C_{A} where for example 0≤K≤1. A value that is equal or close to K=0 means that the scenario is avoided at every cost, and K=1 means that the scenario is avoided based on optimal costs. A value K>1 (e.g., K=1, 3 or 4) means that the scenario is to some extend ignored (no action “A” taken or taken even though the probability weighted costs are not optimal) even though the related costs might be high.

If there is only one scenario i, or if only one scenario i is dominant with respect to costs at a specific time or situation, the above relation can be simplified as follows:

$${P}_{NA , 1} * {C}_{NA , 1} + ( 1 - {P}_{NA , 1} ) * {C}_{NA , not ( 1 )} \geq {P}_{A , 1} * {C}_{A , 1} + ( 1 - {P}_{A , 1} ) * {C}_{A , not ( 1 )} + {C}_{ADJUSTMENT} .$$

In this case, P_{NA,1} can be equated with P_{NA}, P_{A,1} can be equated with P_{A}, C_{A,1} can be equated with C_{A}, C_{NA,1} can be equated with C_{NA}, C_{A,not(1)} can be equated with C_{A,not}, and C_{NA,not(1)} can be equated with C_{NA,not}.

The probability weighted cost related to not performing an action (“NA”) and not getting the scenario might be significantly smaller compared to the probability weighted cost related to not performing an action (“NA) and getting the scenario, (i.e., (1−P_{NA,1})*C_{NA,not(1)}<<P_{NA,1}*C_{NA,1}. This part of the relation could be neglected, resulting in:

$${P}_{NA , 1} * {C}_{NA , 1} \geq {P}_{A , 1} * {C}_{A , 1} + ( 1 - {P}_{A , 1} ) * {C}_{A , not ( 1 )} + {C}_{ADJUSTMENT} .$$

In some cases, the probability weighted cost of the scenario not occurring if an action is taken could be very low compared to the probability weighted cost of the scenario occurring if an action is taken (i.e., (1−P_{A,1})*C_{A,not(1)}<<P_{A,1}*C_{A,1}). The relation could be simplified, resulting in:

$${P}_{NA , 1} * {C}_{NA , 1} \geq {P}_{A , 1} * {C}_{A , 1} + {C}_{ADJUSTMENT} .$$

The method also includes selecting or calculating a break even threshold based on probabilities (P_{NA,1}) of encountering a drilling scenario if no mitigating action is performed, probabilities (P_{A,1}) of encountering the scenario if a mitigating action is performed, and/or costs associated therewith. As stated above, costs can include an estimated overall adjustment cost (C_{ADJUSTMENT}) of performing an action meant to mitigate the scenario. The break even threshold may correspond to a probability value (probability threshold) calculated for example from the above relation as:

$${P}_{NA , 1} \geq {P}_{A , 1} * ( {C}_{A , 1} / {C}_{NA , 1} ) + ( {C}_{ADJUSTMENT} / {C}_{NA , 1} ) .$$

The break even threshold is selected to balance the probabilities and costs. In other words, the system is configured to perform a mitigating action if the probability P_{NA,1} is high enough and the cost of acting C_{A,1} is less than or equal to the cost of not acting to address an upcoming drilling scenario (i.e., the break even threshold is a threshold value at which the cost of an action and a cost of not acting or performing another action balances or breaks even). In an embodiment, the system is configured to perform an action if (assuming C_{ADJUSTMENT} is small):

$${P}_{N A , 1} \geq {P}_{A , 1} * ( {C}_{A , 1} / {C}_{NA , 1} ) .$$

In simplifying or changing the relation by means of negligible or low costs, the relation could be simplified as such, resulting in different relations as shown above. Simplifying could involve only relating the cost of one scenario “i” at a time. This could be the scenario that is dominant with respect to costs or safety or other measures typically applied in the drilling industries. As stated above, different factors “K” could be used to account for scenarios that are not compromised, such as safety or generally HSE (health, safety and environment), where an action is always taken no matter what the resulting cost will be. Generally, in the relations above and if different scenarios are weighted against each other, the interrelationship could be captured by calculation of the dependency of two scenarios, e.g., both never occur at a time, both always occur at a time or occur at a time according to a certain statistical measure that can be calculated from data, simulations, statistical simulations, etc.

A cost can be functions of different scenario-costs with an estimated cost of encountering a scenario. A probability threshold can be selected to optimally balance the costs and optimize a trade-off between these costs to avoid reacting (performing an action) too early or too late to an expected scenario.

The probabilities (P) and costs (C) can be values between 0 and 1, a percentage between 0 and 100%, or another similar quantification of probability. The probability P and the cost values C can be dependent on one or more of various kinds of operational parameters, such as the ROP, the rotational speed at the bit, the flow rate, the WOB, and others. For example, the cost can be higher if the reaction (mitigating action) for a scenario is later, or a probability for a scenario to occur is increasing with certain measurements such as vibrations, loads measured downhole or on the surface or the like (such as stringer detection). The cost can have variable elements and constant element associated with it, such as a cost of the adjustment of the parameters C_{ADJUSTMENT}. The C_{ADJUSTMENT} could be associated with a cost of performing an action, e.g., because it is associated for example to the need to stop drilling for a certain time, drill with a lower rate of penetration (ROP), or rotating off-bottom.

In an embodiment, the break even threshold is used with the reference data and associated probability information to calculate a parameter threshold, which is a threshold value of a set of parameter values (and/or statistical attributes of parameter values) that is indicative of the potential of encountering a drilling scenario. During an operation, the monitoring and decision system monitors sensor data and compares the sensor data to the parameter threshold. If the sensor data indicates that a set of parameter values exceeds the parameter threshold, a mitigating action is performed to avoid the scenario or mitigate any negative effects.

It is noted that there may be multiple costs and/or trade-offs related to a given drilling scenario. In such cases, cost of no action C_{NA} and/or cost of acting C_{A} can be calculated as an aggregate value based on multiple constituent costs, for example, involving different scenarios and associated costs. In this case the more general equation C_{NA}≥C_{A} can be used to balance the costs.

As noted above, probabilities may be correlated with measured sets of parameters. Thus, in an embodiment, the system determines whether the probability P_{NA} is greater than a probability threshold (break even threshold) by comparing measured sets or parameters to a parameter threshold corresponding to the probability threshold.

One example includes a so-called stringer drilling scenario. In such a scenario, a drill bit hits a stringer, and based on the angle of attack, a local dogleg might occur which bends the drilling system because the borehole is deviated. The probabilities and costs can be balanced for such a scenario as follows (where “i” is replaced with “local dogleg”)

$${P}_{NA , local dogleg} * {C}_{NA , local dogleg} + ( 1 - {P}_{NA , local dogleg} ) * {CA}_{NA , not ( local dogleg )} \geq {P}_{A , local dogleg} * {C}_{A , local dogleg} + ( 1 - {P}_{A , local dogleg} ) * {C}_{A , not ( local dogleg )} + {C}_{ADJUSTMENT} .$$

In this example, other related costs are neglected. P_{NA,local dogleg} and P_{A,local} dogleg are the probabilities that a local dogleg is manifesting at a certain time and in a certain environment while drilling with no action (NA) and with an action (A) taken. An action is taken that is aiming to reduce the costs and reduce the probability of a local dogleg if the action is performed, where the probability of a local dogleg is higher if no action is taken (P_{NA,local dogleg}>P_{A,local dogleg}). The cost of taking action but still getting a local dogleg (C_{A,local dogleg}) and the cost taking no action and getting a local dogleg (C_{NA,local dogleg}) can be different or assumed to be equal (C_{local dogleg}=C_{NA,local dogleg}=C_{A,local dogleg}) if action “A” or no action “NA” is taken. The typical action to address a local dogleg that might occur is to change drilling parameters (such as reducing WOB or RPM to reduce the rate of penetration). This change might be called negative drill break scenario. If no action “NA” is taken, the WOB or RPM to reduce the rate of penetration is not reduced, and if no local dogleg is occurring, the costs C_{NA,not(local dogleg)} could be assumed comparably low, resulting in:

$${P}_{NA , local dogleg} * {C}_{loacl dogleg} \geq {P}_{A , local dogleg} * {C}_{local dogleg} * {C}_{local dogleg} + ( 1 - {P}_{A , local dogleg} ) * {C}_{A , not ( local dogleg )} + {C}_{ADJUSTMENT} .$$

The probability threshold can then be expressed as:

$${P}_{NA , local dogleg} \geq {P}_{A , local dogleg} + ( 1 - {P}_{A , local dogleg} ) * ( {C}_{A , not ( local dogleg )} / {C}_{local dogleg} ) + ( {C}_{ADJUSTMENT} / {C}_{local dogleg} ) ,$$

or if the cost of the adjustment of the parameters (C_{ADJUSTMENT}) is comparably small, the probability threshold can be expressed as:

$${P}_{NA , local dogleg} \geq {P}_{A , local dogleg} + ( 1 - {P}_{A , local dogleg} ) * ( {C}_{A , not ( local dogleg )} / {C}_{local dogleg} ) .$$

The cost C_{A,not(local dogleg)} might be comparably high. The cost is related to a lower rate of penetration or drilling efficiency (action “A”) chosen to avoid the local dogleg while the local dogleg does not occur.

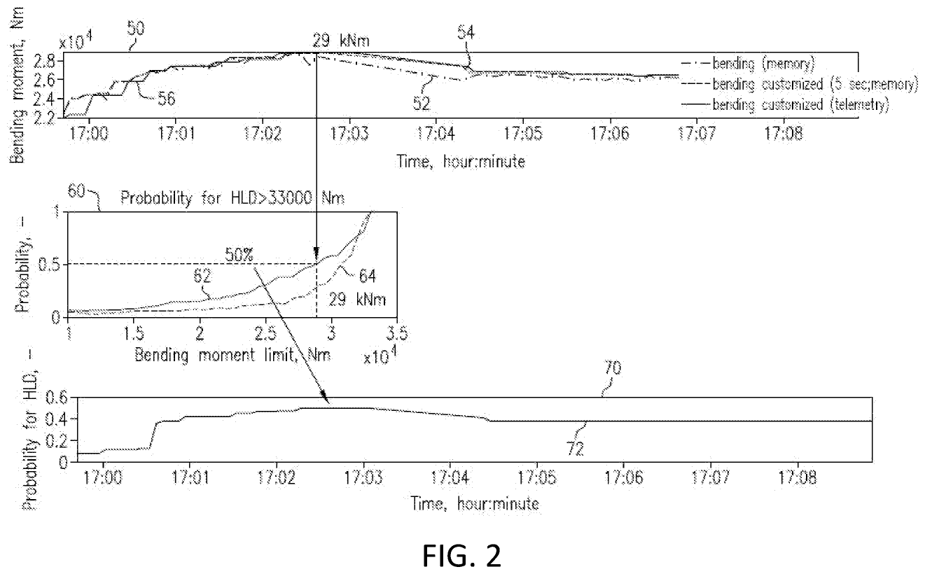

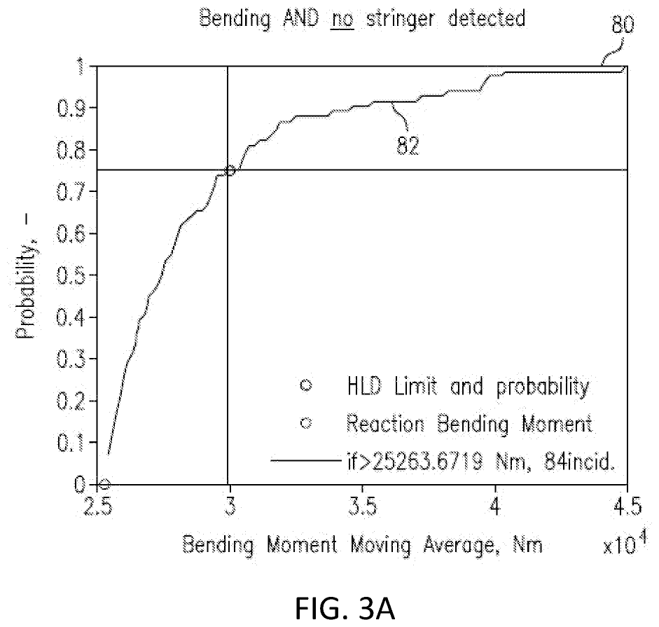

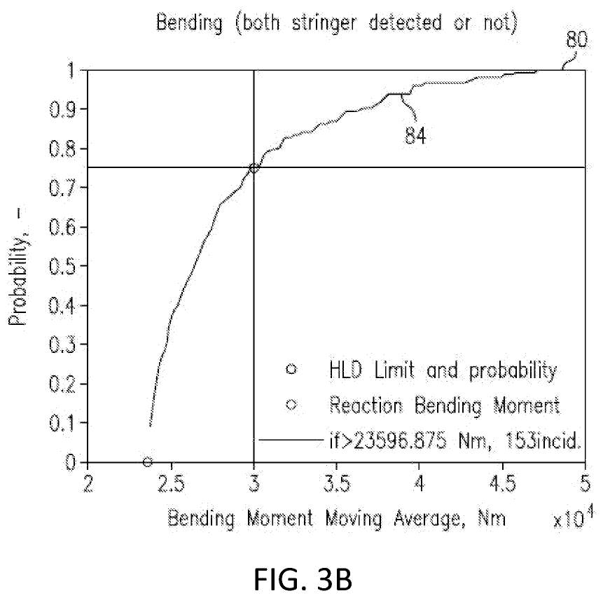

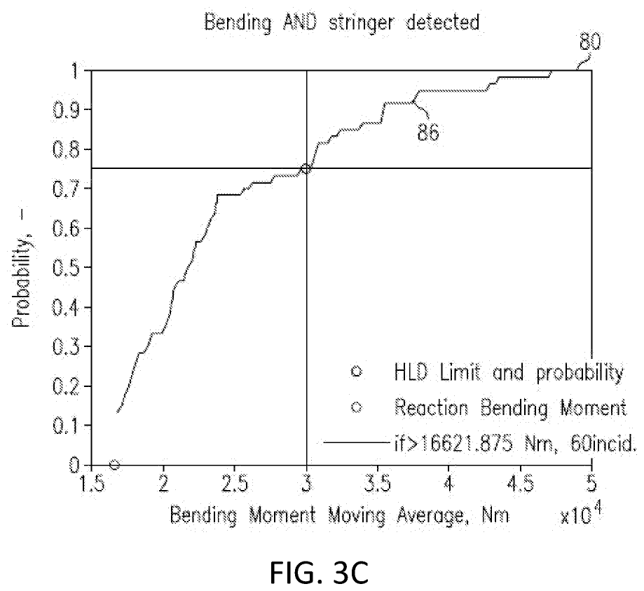

FIGS. 2 and 3 depict examples of reference data and statistical analyses of reference data for a drilling scenario associated with the presence of stringers in the path of a drill string. In these examples, the drilling scenario is the occurrence of excessive bending or a high local dogleg (HLD) due to a drill string contacting or interacting with a stringer. It is noted that these examples are not intended to be limiting, as embodiments described herein can be applied to any of a variety of drilling scenarios and measurements. Examples of other scenarios include occurrences of HLDs due to rate of penetration or ROP (using probabilities that a HLD will occur given a ROP value).

In the examples of FIGS. 2 and 3, measurements used to detect stringers, determine probabilities and make mitigation decisions include bending moment measurements. However, any appropriate measurements can be used, either in place of or in combination with bending moment measurements. Such measurements may include vibration measurements (tangential and/or radial acceleration measurements), torsional torque measurements and/or frequency measurements related to high frequency torsional oscillations (HFTOs) (acceleration measurements), and inclination or azimuth measurements (directional measurements, such as magnetometer measurement).

Bending moment and/or other parameter measurements (acceleration, strain, torque) can be used in combination with a stringer detection system in a BHA (e.g., as a LWD or MWD system). The stringer detection system analyzes dynamic acceleration and torque parameters and outputs an indicator to a control system (e.g., surface processing unit 34) using mud pulse telemetry transmission, or outputs to a downhole processor 32. For example, the stringer detection system transmits information in defined intervals (e.g., 15 second intervals) that can include bending moment measurements and/or an indicator value (“zero” if a stringer is not detected and “one” if a stringer is detected). An indicator value of one is referred to as a “stringer alarm.”

FIG. 2 depicts an example of reference data acquired during a drilling operation, and an example of a derivation of probabilities of encountering a drilling scenario. In this example, a HLD is defined as a bending moment of at least about 33 kilo-Newton-meters (kNm).

FIG. 2 includes a graph 50 of bending moment as a function of time. Curve 52 shows bending moment as measured by downhole sensors. Curve 54 shows a customized bending moment, representing the maximum bending moment in each 5 second interval of an acquisition time (x-axis). Curve 56 shows bending moment as transmitted to the surface processing unit 34 or outputted to the downhole processor 32 by the stringer detection system.

The bending moment information is statistically analyzed to estimate the probability of producing a HLD given a set of parameter values, which in this example is a bending moment limit, also referred to herein as parameter limit (of the parameter values). The parameter limit is a limit for a drilling operation parameter. A “bending moment limit” is a value of the bending moment associated with the occurrence of a HLD. A HLD is indicated if a bending moment value is greater than or equal to the bending moment limit. Other measurements indicating a local dogleg are inclination and azimuth measurements (magnetometer measurements and/or gravity measurements), which could be used if bending moment does not exist as measurement. The bending moment limit could for example be associated with a tool limit (that the tool is not damaged) or to a limitation from completion steps (e.g. to get the casing or liner down into the borehole).

For example, FIG. 2 shows a graph 60 of a probability of reaching a bending moment limit of about 33 kNm (HLD encountered) given a certain bending moment value. Curve 62 shows the probability of a HLD occurring if a certain bending moment is measured and a stringer was detected by the stringer detection system. Curve 64 shows the probability of a HLD occurring if a certain bending moment is measured and a stringer was not detected by the stringer detection system. As an illustration, a bending moment of about 29 kNm is associated with a 50% probability of a HLD if a stringer was detected. That is, if a bending moment of 29 Nm is reached the probability to detect a bending moment of 33 kNm in a future time interval or a future drilled depth interval is 50%. If a stringer was not detected, the bending moment of about 29 kNm is associated with a probability of about 25% to reach a bending moment of 33 kNm in a future time interval or a future drilled depth interval.

Graph 70 includes a curve 72 of probability based on the bending moments of curve 52. The drilling operation has been interrupted from 29 kNm to avoid a further increase of the bending moment (local dogleg) by initiation of proper (adapted) drilling parameters (action performed), e.g., by initiation of a negative drill break procedure. Graph 70 displays the probability of reaching a bending moment of 33 kNm over a time drilled. If a probability of 50% is reached (probability of 50% to reach a bending moment of 33 kNm during a future time or drilled depth interval) a mitigating action is performed to avoid a HLD. In case a stringer is detected the probability of 50% is reached at 29 kNm. In this specific example the probability threshold is 50%. In case of stringer drilling, a future time interval refers to the time it takes to drill a distance (depth interval) until the stringer is drilled. This is typically a distance of 1 meter (m) to several meters, such as 1 m to 3 m, 1 m to 5 m, or 1 m to 10 m. Assumed a rate of penetration of 30 m/h, the future time interval would be in the range of 120 s for drilling a distance of 1 m to 1200 s for drilling a distance of 10 m.

These probabilities can be used to inform whether to perform an action, and to inform the timing at which an action should be performed based on a selected probability threshold (break even threshold). For example, if a probability threshold of 30% is desired, then an action should be performed when a bending moment threshold of about 25 kNm is reached and a stringer is detected. If a stringer is not detected, then an action should be performed when a bending moment threshold of about 29 kNm is reached.

FIGS. 3A-3C depict examples of statistical reference data that can be used to calculate a parameter threshold. In these examples, the parameter threshold is a bending moment threshold moving average calculated based on measurements performed in an offset well. Each example is represented using a graph of probability as a function of bending moment moving average, given a different bending moment threshold. Curves 82, 84 and 86 in FIGS. 3A-3C represent the probability distribution of the maximum bending moment, in case a bending moment marked by the cross-hairs is reached. Each curve is a probability distribution of the maximum bending moment that has been statistically measured during the next meters that have been drilled (drilled depth interval) in the different scenarios. In each scenario, the bending limit has been determined in a way that a bending moment of 30 kNm (definition of HLD that may not be exceeded) is only passed with a probability of 25%, or that a bending moment of 30 kNm is not passed with a probability of 75%. Further, curve 82 shows the probability of getting a HLD (defined as at least about 30 kNm, shown as vertical black line) if no action was performed (no interruption of drilling operation and parameters are not changed) at a bending moment threshold of about 25 kNm (and no stringer was detected). Curve 84 shows the probability of getting a HLD if no action was performed at a bending moment threshold of about 23.6 kNm (whether or not a stringer was detected), and curve 86 shows the probability of getting a HLD if no action was performed at a bending moment threshold of about 16.6 kNm (and a stringer was detected).

In this example, if the probability threshold P_{T} is selected as a probability P of 25% (i.e., a 25% probability of getting a HLD assuming no action, or 75% of not getting a HLD assuming no action), the bending moment threshold should be about 25 kNm if no stringer is detected. If a stringer is detected, the bending moment threshold should be about 16.6 kNm. If no stringer detection is used, the bending moment threshold should be about 23.6 kNm to yield a 25% chance of getting a HLD or a 75% chance of not getting a HLD.

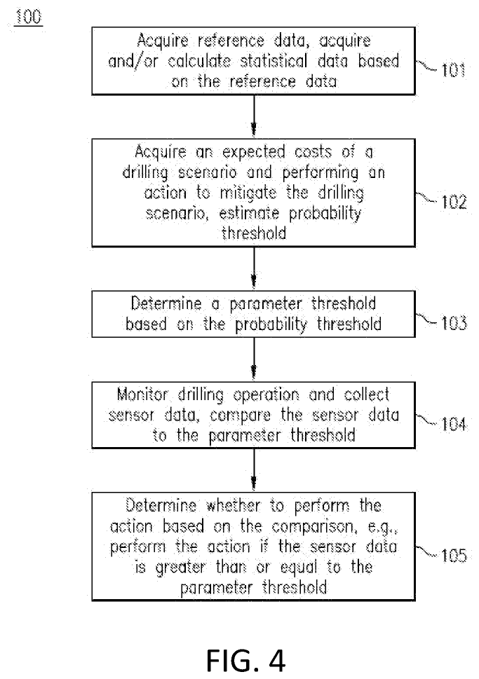

FIG. 4 is a flow diagram representing a method 100 of monitoring a drilling operation and making decisions related to drilling scenarios. The method 100 includes a plurality of method steps or stages, represented by blocks 101-105. The method 100 may include all of the stages or steps in the order described. However, certain stages or steps may be omitted, stages may be added, or the order of the stages changed.

At block 101, reference data is acquired from well offset data, modelling or other sources of information. The reference data includes or is analyzed to derive statistical data or statistical attributes that indicate a likelihood of encountering a drilling scenario given a set of parameter values. For example, statistical data indicating the probability of encountering a stringer and causing a HLD is provided for each of a plurality of bending moment measurement values. As noted above, other types of parameters may be used in addition to or in place of bending parameters (e.g., acceleration (HFTO), weight on bit or RPM, ROP, etc.).

At block 102, if the drilling scenario is determined to be likely to occur, expected costs associated with the drilling scenario are acquired with and without an action performed. In addition, expected costs associated with a mitigating action are acquired. An action may be an active change of a drilling operation, which could be an adjustment of the operational drilling parameters, mud properties, etc. but could also include tripping and changing the drilling system (non productive time (NPT)) or even a scenario where a side track is more beneficial compared to continue drilling.

A break even threshold is determined based on the costs. For example, a cost of a HLD due to a stringer is estimated, and a cost of transitioning to a stringer drilling mode (adapted WOB and/or RPM to reduce ROP) is estimated.

At block 103, using the break even threshold and the reference data, a parameter threshold is selected that corresponds to the probability threshold. For example, a bending moment threshold corresponding to the probability threshold and a bending moment limit corresponding to a parameter limit is selected from the reference data and statistical analysis thereof (statistical data). The parameter threshold may include (e.g., depend on) a bending moment threshold and an indication as to whether or not a stringer was detected by a detection system at the time the parameter threshold was reached in the reference data.

At block 104, a drilling operation is performed. The operation is monitored and sensor data is collected in real time. The sensor data is compared to the parameter threshold. For example, during the operation, measurements from various sensors, including bending moment measurements, are acquired and compared to the parameter threshold, such as a bending moment threshold.

At block 105, the comparison is used to determine whether or not to perform the mitigating action. If the sensor data is less than the parameter threshold, the current drilling mode is maintained (i.e., no mitigating action is performed at the current time). If the sensor data meets or exceeds the parameter threshold, the mitigating action is performed. The action can be performed immediately or after a pre-configured delay. In this way, a drilling scenario can be addressed in a timely manner and in a way that optimizes the trade-off between costs.

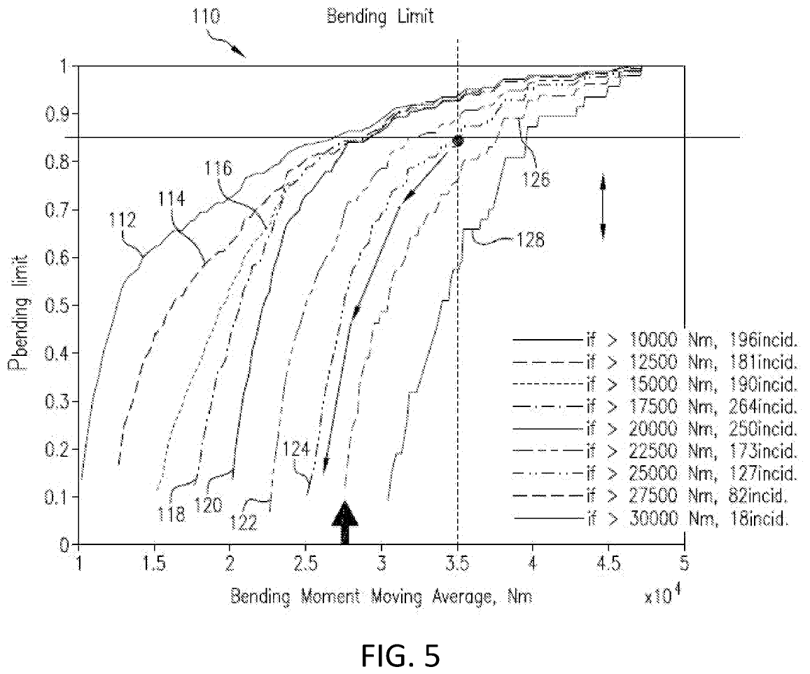

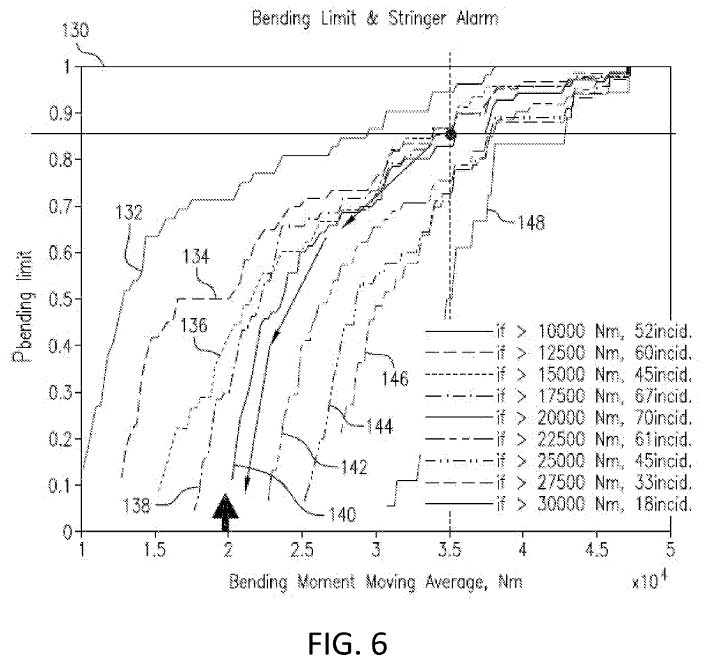

FIGS. 5 and 6 illustrate an example of the method 100 in the context of making reaction decisions (decisions for performing or not performing an action) during a drilling operation to address drilling scenarios in the form of HLD conditions resulting from interacting with stringers. In this example, the set of parameters include bending moment measurements, and the parameter threshold is a bending moment threshold value, referred to herein as a “bending threshold.” The action is a negative drill break procedure, which may include reducing ROP, reaming and/or changing other drilling parameters to avoid excessive bending and/or damage.

In this example, the cost C_{scenario} (which can be equated with C_{NA,local dogleg}) is the cost of a HLD and/or reaming the borehole to address a HLD, which may be defined in terms of lost time or monetary cost. The cost C_{action} (which can be equated with C_{ADJUSTMENT}) is the cost of the negative drill break procedure. The probability threshold (P_{T}) could for example be defined as based on simplifying assumptions (the costs of the drilling operations without hitting the stringer (C_{NA,not(local dogleg)}) are negligible):

$$Pr \geq Q + {C}_{action} / {C}_{scenario} .$$

A normal drilling mode (e.g., sand drilling mode) can be maintained if:

$$P * {C}_{scenario} < Q * {C}_{scenario} + {C}_{action} .$$

An action such as the negative drill break procedure or a change in drilling mode (e.g., transition from sand drilling mode to stringer drilling mode) should be performed if:

$$P * {C}_{scenario} \geq Q * {C}_{scenario} + {C}_{action} .$$

Herein P is the probability of a local dogleg (the scenario) if no action is taken (P_{NA}), that is, no negative drill break procedure or adjustment of operational parameters was performed. Q is the probability of getting a local dogleg even if the negative drill break procedure is initiated and action is taken (P_{A}). Note that the cost of a scenario can also be different for the scenario with the negative drill break procedure (the action) (C_{scenario,action}) and without the negative drill break procedure (C_{scenario,noaction}), or the cost can be dependent on operational parameters which would lead to a selection of optimal operational parameters with the equation.

$$P * {C}_{scenario , noaction} \geq Q * {C}_{scenario , action} + {C}_{action} .$$

FIG. 5 shows an example of a statistical analysis of reference data. In this example, reference data such as measurement data was collected during a drilling operation in an offset well, and analyzed to derive probabilities of reaching a bending moment limit (i.e., getting a HLD) given a selected bending moment threshold. The probabilities are shown in a graph 110. The probability P_{NA} that a certain bending moment (corresponding to a bending moment limit) shown on the x-axis is drilled if no action is taken is P_{NA}=1−P_{bending limit} (each curve is associated with a different bending moment threshold), for each of a plurality of bending moment thresholds (defined as bending moment moving averages). P_{bending limit} on the y-axis defines the probability that the bending moment is staying below a certain value on the x-axis. That is, the value P_{NA}=1−P_{bending limit} gives the value that the bending moment on the x-axis is reached or exceeded. This specific bending moment is the selected bending moment threshold.

Curve 112 represents a probability (1−P_{bending limit}) of reaching a given bending moment value (a “bending limit”) when a bending moment threshold of about 10 kNm is reached. Curve 114 represents the probability (1−P_{bending limit}) for a bending moment threshold of about 12.5 kNm, curve 116 represents the probability (1−P_{bending limit}) for a bending moment threshold of about 15 kNm, and curve 118 represents the probability (1−P_{bending limit}) for a bending moment threshold of about 17.5 kNm. Curves 120, 122, 124, 126 and 128 represent the probability (1−P_{bending limit}) for bending moment thresholds of about 20 kNm, 22.5 kNm, 25 kNm, 27.5 kNm and 30 kNm, respectively.

In an example, the bending moment limit associated with a HLD is about 30 kNm. The probability threshold is calculated to be 15% (1−P_{bending moment}), e.g., from the considerations that relate the expected cost of different scenarios to each other. Based on the probability threshold of 15%, the determined probability distributions (curves 112, 114, 116, 118, 120, 124, 126, 128), and a known bending moment limit, a bending moment threshold can be determined. In graph 110, curve 122 intersects the point of a bending moment limit of 30 kNm (defined as a HLD) and a probability threshold of P_{T}=15% ((1−P_{bending moment})). Curve 122 corresponds to a bending moment threshold of 22.5 kNm. Accordingly, 22.5 kNm is the bending moment threshold for use during a drilling operation.

In another example, the bending moment limit associated with HLD is about 35 kNm and the probability threshold P_{T} is calculated to be 15%. Curve 124 intersects the point of a bending moment limit of 35 kNm (defined as a HLD) and a probability of P_{T}=15% on the graph 110 (as illustrated in FIG. 5), thus 25 kNm is selected as the bending moment threshold for use during a drilling operation. During the drilling operation, the bending moment moving average is calculated in real time, this is while drilling the borehole, and a mitigating action is taken, such as changing the drilling mode to stringer drilling if the bending moment moving average reaches or exceeds the bending moment threshold of about 25 kNm. Changing the drilling mode to stringer drilling may include reducing the ROP by reducing for example WOB and/or RPM, initiating a negative drill break procedure, back reaming the well, or other actions.

FIG. 6 shows another example of statistical data derived from the same reference data used in FIG. 5. In this example, the probabilities are based on a selected bending moment threshold and whether a stringer alarm was generated in conjunction with reaching the bending moment threshold. A stringer alarm is generated based on the occurrence of vibration (high-frequency torsional oscillations) in a previous time interval (e.g., the last 30 seconds) of the drilling operation. The different curves in both figures show that a different bending moment threshold is needed in different scenarios. The scenario in FIG. 5 shows data that does not differentiate between a stringer that has been detected or not, and the data used in FIG. 6 is corresponding to bending moments that have been measured when a stringer has been detected previously and is being drilled. It shows that if the stringer is detected, the probability of a HLD of the same bending moment is higher for a lower bending moment threshold. Therefore, with same statistical properties a reaction at a lower bending moment threshold (20 kNm (curve 140 in FIG. 6) versus 25 kNm (curve 124 in FIG. 5)) is appropriate to achieve the same probabilities and an optimal probability weighted cost.

The probabilities are shown in a graph 130 of a probability (1−P_{bending limit}) that no action was taken, for each of a plurality of bending moment thresholds. Curve 132 represents a probability (1−P_{bending limit}) of reaching a bending moment limit of about 30 kNm when a bending moment threshold of about 10 kNm is reached and a probability threshold is calculated to be P_{T}=1−P_{bending limit}=15%. Curve 134 represents the probability (1−P_{bending limit}) of 15% for a bending moment limit of about 34 kNm to be encountered when a bending moment threshold of about 12.5 kNm was detected, curve 136 represents the probability (1−P_{bending limit}) of 15% for a bending moment limit of about 34 kNm to be encountered when a bending moment threshold of about 15 kNm is detected, and curve 138 represents the probability (1−P_{bending limit}) of 15% for a bending moment limit of about 34 kNm to be encountered when a bending moment threshold of about 17.5 kNm is detected. Curves 140, 142, 144, 146 and 148 represent the probability (1−P_{bending limit}) of 15% for bending moment limits to be encountered of about 35 kNm (bending moment threshold 20 kNm), 37.5 kNm (bending moment threshold 22.5 kNm), 37.5 kNm (bending moment threshold 25 kNm), 37.5 kNm (bending moment threshold 27.5 kNm), and 42.5 kNm (bending moment threshold 30 kNm), respectively.

Using the same probability threshold P_{T} of 15%, the bending moment threshold in this example was selected as about 20 kNm (graph 140) to stay with a probability of (1−P_{T})≤85% below the bending moment limit of 35 kNm and exceed with a probability of P_{T}=15% the bending moment limit of 35 kNm. Using the statistical data from FIGS. 5 and 6, two bending moment thresholds can be defined. During a drilling operation, the system will react if a moving average of the bending moment (measured in real time during the operation) reaches a bending moment threshold of about 25 kNm and no stringer alarm is generated (FIG. 5), and will react at a bending moment threshold of 20 kNm if a stringer alarm is generated (FIG. 6).

The statistical data is not limited to bending moment and/or stringer alarm data. For example, bending trends can be used as part of the statistical data (e.g., detected by directional sensors (magnetometers, accelerometers).

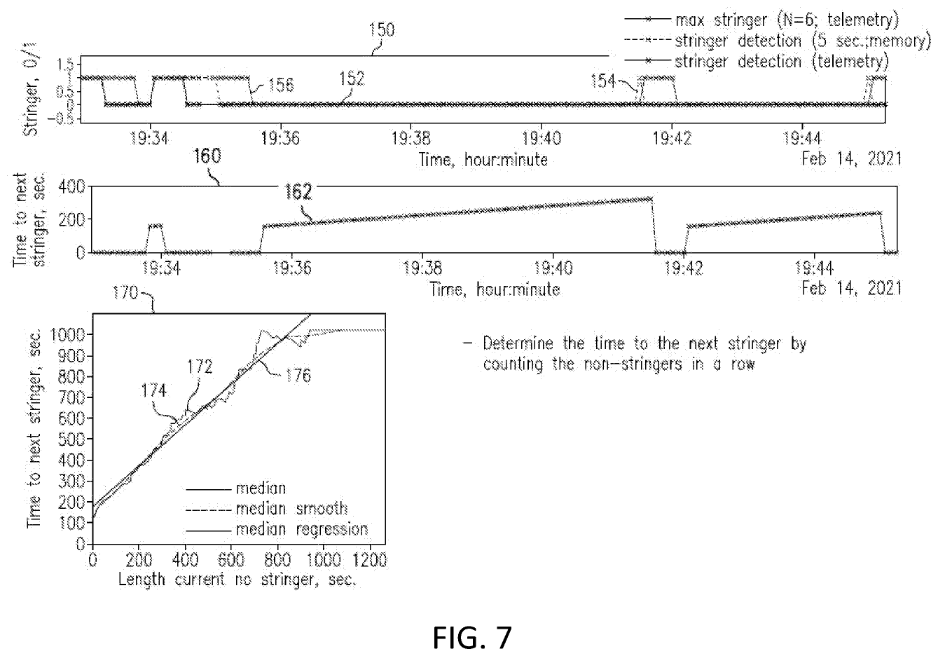

Another example of reference data and statistical data is shown in FIG. 7. In this example, the set of parameter values includes one or more values indicative of time between successive stringers. The set of parameter values may include this time information, alone or in combination with other parameter values (e.g., bending moment).

FIG. 7 includes reference data in the form of a graph 150 of outputs by a stringer detection system. The stringer detection system in this example periodically outputted an indicator. The indicator was zero if no stringer detected, or one (a stringer alarm) if a stringer was detected. Curve 152 represents indicator values over time. Curve 154 indicates whether a stringer has been detected (value of one) downhole in the last time frame of reference (e.g., 5 seconds (s)) that has been stored in the memory. Curve 156 indicates a stringer (i.e., magnitude is one) if at least one of the last 6 updates (6 last time frames) in the memory have indicated a stringer. The length of the time frame of reference may be different. A time frame of reference may be between 1 to 20 s, between 1 to 10 s, or between 1 to 5 s.

The indicator values were analyzed to derive graph 160, which shows on the y-axis the time (in seconds) which is statistically expected until the next stringer is detected. The time separation is represented by curve 162. Values of zero correspond to times when a stringer was detected and is drilled. Graph 170 shows on the y-axis the time to a next stringer from a detected stringer as a function of the length (time) of between the detected stringer and the next stringer. Curve 172 is the median time between successive stringers, curve 174 is a smoothed median time, and curve 176 is a median regression. This data can be used to estimate probabilities and make reaction decisions as discussed herein.

Various other drilling scenarios may be encountered. An example of a drilling scenario is an occurrence of a failure and associated dysfunctions due to a given load, such as a static load (e.g., torque, weight/normal force, bending moment) or a dynamic load such as vibrations (e.g., axial, lateral, and torsional vibrations) or a combination of one or more loads (e.g., also with temperature, erosion, etc.). The cost can be balanced based on the probability of a failure with non-productive time and associated costs of tripping and maintenance, as compared to taking mitigating action that includes less aggressive operational parameters (e.g., WOB, RPM) with lower rate of penetration or drilling efficiency but with a lower probability of non-productive time.

The method in this example represents a trade-off between selecting a certain change of operational parameters. For example, one change could be hole cleaning, which may benefit from higher rotary speed values of the drill string, and decrease the chance of cuttings accumulating in the borehole, with associated costs of stuck pipe or the like. On the contrary, vibrations and associated costs (reliability, non-productive time) might increase with higher rotary speed.

One mitigation strategy for a certain vibration phenomenon might be associated with an increase of the weight on bit (e.g., increased lateral vibrations) and another strategy associated with a reduction of the weight on bit. Based on the expected weighted costs of both vibrations and the likelihood of a failure and non-productive time associated, the drilling parameters can be changed based on the optimal costs derived above from probabilities and cost of different vibration scenarios. In this example, the probability of getting a stuck pipe could be added which also is a function of the bit rotary speed. Therefore, from the above relations, optimal costs of a bit rotary speed (RPM) could be changed with optimal associated overall costs as long as the probability weighted cost of the “current set point” that is associated with “no action” is smaller than the probability weighted cost of the “target set point” that is associated with an “action”:

$${P}_{hole cleaning issue , current set point} * {C}_{hole cleaning issue} + {P}_{failure , current set point} * {C}_{failure} \geq {P}_{hole cleaning issue , target set point} * {C}_{hole cleaning issue} + {P}_{failure , target set point} * {C}_{failure} + {C}_{change to target set point} .$$

In this relation, the action is changing the set point to the target set point for bit rotary speed. P_{hole cleaning issue,current set point} can be equated with P_{NA,not}, C_{hole cleaning issue} can be equated with C_{NA,not}, P_{failure current set point} can be equated with P_{NA}, C_{failure} can be equated with C_{NA}. P_{hole cleaning issue, target set point} can be equated with P_{A,not}, P_{failure, target set point} can be equated with P_{A}, and C_{change to target setpoint} can be equated with C_{ADJUSTMENT}. The approach can be used to derive an optimal set point by minimizing the function:

$$f ( set point ) = {P}_{hole cleaning issue , current set point} * {C}_{hole cleaning issue} + {P}_{failure , current set point} * {C}_{failure} - ( {P}_{hole cleaning issue , target set point} * {C}_{hole cleaning issue} + {P}_{failure , target set point} * {C}_{failure} + {C}_{change to target set point} ) ,$$

with respect to a certain set point.

Another trade-off could be drilling with higher ROP, creating a deviated well with more doglegs, versus bringing the liner or casing down which asks for a smooth borehole. A further trade-off could be drilling with higher ROP or with a smoother borehole, versus geo-steering, e.g., to have an optimal production of carbonates which asks for a certain distance to the oil water contact or alike.

Set forth below are some embodiments of the foregoing disclosure:

Embodiment 1: A method of performing a drilling operation, comprising: acquiring sensor data during a drilling operation performed in a subterranean region; estimating a first probability PA of a drilling scenario manifesting if a first action is performed, and estimating a second probability PNA of the drilling scenario manifesting if the first action is not performed or a second action is performed; calculating a break even threshold based on the first probability and the second probability, the break even threshold calculated based on a set of costs including a first cost CA of performing the first action to mitigate the drilling scenario and a second cost CNA associated with the drilling scenario if the first action is not performed or the second action is performed; and based on the acquired sensor data and the break even threshold, performing the first action.

Embodiment 2: The method of any prior embodiment, wherein the first cost CA is weighted based on the first probability PA and the second cost CNA is weighted based on the second probability PNA.

Embodiment 3: The method of any prior embodiment, wherein the acquired sensor data includes values of a drilling operation parameter, and performing the first action is based on a limit for the drilling operation parameter.

Embodiment 4: The method of any prior embodiment, wherein estimating the first probability PA includes an indicator of the drilling scenario to occur or not to occur, the indicator based on measured data using a monitoring system.

Embodiment 5: The method of any prior embodiment, wherein the indicator indicates a stringer and the monitoring system is a stringer detection system.

Embodiment 6: The method of any prior embodiment, wherein the cost CNA is a cost if the scenario manifests and the first action is not performed or the second action is performed, the cost CA is a cost if the scenario manifests and the first action is performed, and the set of costs includes a cost CNA,not if the scenario does not manifest and the first action is not performed or the second action is performed, and a cost CA,not if the scenario does not manifest and the first action is performed, wherein the first action is performed based on:

$${P}_{N A} * {C}_{N A} + ( 1 - {P}_{N A} ) * {C}_{NA , not} \geq {P}_{A} * {C}_{A} + ( 1 - {P}_{A} ) * {C}_{A , not} + {C}_{A D J U S T M E N T} ,$$

where C_{ADJUSTMENT} is a cost associated with an adjustment of a drilling parameter.

Embodiment 7: The method of any prior embodiment, wherein the action is performed based on the probability PNA being above the break even threshold.

Embodiment 8: The method of any prior embodiment, further comprising associating the drilling scenario with a margin value, the margin value indicating an importance of avoiding the drilling scenario regardless of cost.

Embodiment 9: The method of any prior embodiment, further comprising comparing the cost CNA to a cost function based on multiplying the cost CA by the margin value, and performing the action based on the cost CNA being greater than or equal to the cost function.

Embodiment 10: The method of any prior embodiment, wherein the first probability and the second probability are based on at least one of: bending moment values, output values of a stringer detection system, and times between successive stringers.

Embodiment 11: The method of any prior embodiment, wherein the first probability PA and the second probability PNA are determined based on a statistical analysis of reference data.

Embodiment 12: The method of any prior embodiment, wherein the reference data is acquired from at least one of: an offset well drilling operation, and a simulation of the drilling operation.

Embodiment 13: The method of any prior embodiment, wherein the drilling scenario is an occurrence of a high local dogleg in a drill string due to a stringer in the subterranean region.

Embodiment 14: The method of any prior embodiment, wherein the reference data includes bending moment values.

Embodiment 15: A system for performing a drilling operation, comprising: a processing device configured to acquire sensor data during the drilling operation, the processing device configured to perform: acquiring sensor data during a drilling operation performed in a subterranean region: estimating a first probability PA of a drilling scenario manifesting if a first action is performed, and estimating a second probability PNA of the drilling scenario manifesting if the first action is not performed or a second action is performed; calculating a break even threshold based on the first probability and the second probability, the break even threshold calculated based on a set of costs including a first cost CA of performing the first action to mitigate the drilling scenario and a second cost CNA associated with the drilling scenario if the first action is not performed or the second action is performed; and based on the acquired sensor data and the break even threshold, performing the first action.

Embodiment 16: The system of any prior embodiment, wherein the cost CNA is a cost if the scenario manifests and the first action is not performed or the second action is performed, the cost CA is a cost if the scenario manifests and the first action is performed, and the set of costs includes a cost CNA.not if the scenario does not manifest and the first action is not performed or the second action is performed, and a cost CA.not if the scenario does not manifest and the first action is performed, wherein the first action is performed based on:

$${P}_{N A} * {C}_{N A} + ( 1 - {P}_{N A} ) * {C}_{NA , not} \geq {P}_{A} * {C}_{A} + ( 1 - {P}_{A} ) * {C}_{A , not} + {C}_{A D J U S T M E N T} ,$$

where C_{ADJUSTMENT} is a cost associated with an adjustment of a drilling parameter.

Embodiment 17: The system of any prior embodiment, wherein the first probability P_{A} and the second probability P_{NA} are based on at least one of: bending moment values, output values of a stringer detection system, and times between successive stringers.

Embodiment 18: The system of any prior embodiment, wherein the first probability PA and the second probability PNA are determined based on a statistical analysis of reference data.

Embodiment 19: The system of any prior embodiment, wherein the reference data is acquired from at least one of: an offset well drilling operation, and a simulation of the drilling operation.

Embodiment 20: The system of any prior embodiment, wherein the drilling scenario is an occurrence of a high local dogleg in a drill string due to a stringer in the subterranean region, and the reference data includes bending moment values.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of #8% or 5%, or 2% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of performing a drilling operation, comprising:
acquiring sensor data during a drilling operation performed in a subterranean region;
estimating a first probability P_{A} of a drilling scenario manifesting if a first action is performed, and estimating a second probability P_{NA} of the drilling scenario manifesting if the first action is not performed or a second action is performed;
calculating a break even threshold based on the first probability and the second probability, the break even threshold calculated based on a set of costs including a first cost C_{A} of performing the first action to mitigate the drilling scenario and a second cost C_{NA} associated with the drilling scenario if the first action is not performed or the second action is performed; and
based on the acquired sensor data and the break even threshold, performing the first action.

2. The method of claim 1, wherein the first cost C_{A} is weighted based on the first probability P_{A} and the second cost C_{NA} is weighted based on the second probability P_{NA}.

3. The method of claim 1, wherein the acquired sensor data includes values of a drilling operation parameter, and performing the first action is based on a limit for the drilling operation parameter.

4. The method of claim 1, wherein estimating the first probability P_{A} includes an indicator of the drilling scenario to occur or not to occur, the indicator based on measured data using a monitoring system.

5. The method of claim 4, wherein the indicator indicates a stringer and the monitoring system is a stringer detection system.

6. The method of claim 1, wherein the cost C_{NA} is a cost if the scenario manifests and the first action is not performed or the second action is performed, the cost C_{A} is a cost if the scenario manifests and the first action is performed, and the set of costs includes a cost C_{NA,not} if the scenario does not manifest and the first action is not performed or the second action is performed, and a cost C_{A,not} if the scenario does not manifest and the first action is performed, wherein the first action is performed based on:
$${P}_{N A} * {C}_{N A} + ( 1 - {P}_{N A} ) * {C}_{NA , not} \geq {P}_{A} * {C}_{A} + ( 1 - {P}_{A} ) * {C}_{A , not} + {C}_{A D J U S T M E N T} ,$$
wherein C_{ADJUSTMENT} is a cost associated with an adjustment of a drilling parameter.

7. The method of claim 1, wherein the first action is performed based on the probability P_{NA} being above the break even threshold.

8. The method of claim 1, further comprising associating the drilling scenario with a margin value, the margin value indicating an importance of avoiding the drilling scenario regardless of cost.

9. The method of claim 8, further comprising comparing the cost C_{NA} to a cost function based on multiplying the cost C_{A} by the margin value, and performing the first action based on the cost C_{NA} being greater than or equal to the cost function.

10. The method of claim 1, wherein the first probability P_{A} and the second probability P_{NA} are based on at least one of: bending moment values, output values of a stringer detection system, and times between successive stringers.

11. The method of claim 1, wherein the first probability P_{A} and the second probability P_{NA} are determined based on a statistical analysis of reference data.

12. The method of claim 11, wherein the reference data is acquired from at least one of: an offset well drilling operation, and a simulation of the drilling operation.

13. The method of claim 1, wherein the drilling scenario is an occurrence of a high local dogleg in a drill string due to a stringer in the subterranean region.

14. The method of claim 11, wherein the reference data includes bending moment values.

15. A system for performing a drilling operation, comprising:
a processing device configured to acquire sensor data during the drilling operation performed in a subterranean region, the processing device configured to perform:
acquiring sensor data during the drilling operation;
estimating a first probability P_{A} of a drilling scenario manifesting if a first action is performed, and estimating a second probability P_{NA} of the drilling scenario manifesting if the first action is not performed or a second action is performed;
calculating a break even threshold based on the first probability and the second probability, the break even threshold calculated based on a set of costs including a first cost C_{A} of performing the first action to mitigate the drilling scenario and a second cost C_{NA} associated with the drilling scenario if the first action is not performed or the second action is performed; and
based on the acquired sensor data and the break even threshold, performing the first action.

16. The system of claim 15, wherein the cost C_{NA} is a cost if the scenario manifests and the first action is not performed or the second action is performed, the cost C_{A} is a cost if the scenario manifests and the first action is performed, and the set of costs includes a cost C_{NA,not} if the scenario does not manifest and the first action is not performed or the second action is performed, and a cost C_{A,not} if the scenario does not manifest and the first action is performed, wherein the first action is performed based on:
$${P}_{N A} * {C}_{N A} + ( 1 - {P}_{N A} ) * {C}_{NA , not} \geq {P}_{A} * {C}_{A} + ( 1 - {P}_{A} ) * {C}_{A , not} + {C}_{A D J U S T M E N T} ,$$
wherein C_{ADJUSTMENT} is a cost associated with an adjustment of a drilling parameter.

17. The system of claim 15, wherein the first probability P_{A} and the second probability P_{NA} are based on at least one of: bending moment values, output values of a stringer detection system, and times between successive stringers.

18. The system of claim 15, wherein the first probability P_{A} and the second probability P_{NA} are determined based on a statistical analysis of reference data.

19. The system of claim 18, wherein the reference data is acquired from at least one of: an offset well drilling operation, and a simulation of the drilling operation.

20. The system of claim 18, wherein the drilling scenario is an occurrence of a high local dogleg in a drill string due to a stringer in the subterranean region, and the reference data includes bending moment values.
